(19) United States
(12) Patent Application Publication
(10) Pub. No.: US 2026/0352288 A1
(43) Pub. Date: Nov. 5, 2026

(54) DETERMINATION OF COMPRESSION RATIOS FOR TEMPORAL-DOMAIN CSI PREDICTION PLUS COMPRESSION WITH MULTIPLE PREDICTED INSTANCES

(71) Applicant: InterDigital Patent Holdings, Inc., Wilmington, DE (US)

(72) Inventors: Anouar Yatribi, Greater London (GB); Mihaela Beluri, Jericho, NY (US); Ahmet Serdar Tan, London (GB); Keya Patani, London (GB); Zihao You, Brooklyn, NY (US); Patrick Tooher, Montreal (CA)

(73) Assignee: InterDigital Patent Holdings, Inc., Wilmington, DE (US)

(21) Appl. No.: 19/198,984

(22) Filed: May 5, 2025

(51) Int. Cl. H04B 7/06; H04B 17/318; H04W 24/10

(52) U.S. Cl. CPC H04B 7/0626; H04B 17/328; H04W 24/10

(57) ABSTRACT

A wireless transmit/receive unit (WTRU) may receive configuration information associated with temporal-domain CSI prediction and compression. The WTRU may perform one or more first measurements on first channel samples in the observation window. The WTRU may perform artificial intelligence machine learning (AIML) based prediction of one or more channel instances to determine one or more predicted channel instances. The WTRU may perform one or more second measurements on the one or more predicted channel instances. The WTRU may determine an estimated prediction accuracy for each of the one or more predicted channel instances based on the one or more first measurements and the one or more second measurements. The WTRU may determine a compression ratio from the set of compression ratios for each of the one or more predicted channel instances based on the one or more first measurements and the determined estimated prediction accuracy.

### BACKGROUND

Artificial intelligence (AI) machine learning (ML) based channel state information (CSI) enhancements may reduce CSI feedback reporting overhead. AI/ML based CSI prediction may mitigate channel aging and/or reduce the CSI feedback overhead.

AI/ML based CSI compression may reduce the overhead with respect to legacy CSI feedback. Performing AI/ML CSI prediction plus compression may improve the CSI performance. In this approach, a first step processing uses multiple historical CSI instances to predict one or more future CSI instances; this is followed by a second step processing that compresses the one or more predicted future CSI instances.

The CSI prediction step uses a single side AI/ML prediction model located at the wireless transmit/receive unit (WTRU). The AI/ML prediction model may be based on a recurrent neural network (RNN) or long short-term memory (LSTM) model architectures to leverage the historical CSI instances (e.g., channel estimates based on the received CSI-RS) in the observation window to predict one or more future CSI instances, depending on the configured value of the prediction window size. The AI/ML-based CSI compression step typically uses a two-sided autoencoder (AE) model, where the encoder part (e.g., WTRU-side encoder) is located at the WTRU-side and performs the compression, while the decoder part, located at the network (NW) side (e.g., NW-side decoder), performs the reconstruction based on the received compressed CSI.

### SUMMARY

Methods and apparatuses may be described herein for channel state information (CSI) enhancements for temporal CSI compression. Methods and apparatuses may be described herein for the determination of compression ratios for temporal-domain CSI prediction plus compression with multiple predicted instances.

A WTRU may receive configuration information associated with temporal-domain CSI prediction and compression. The configuration information may indicate a set of compression ratios associated with compression of predicted CSI instances. The WTRU may receive CSI reference signals (CSI-RSs) in an observation window. The WTRU may perform one or more first measurements on first channel samples in the observation window. The WTRU may perform artificial intelligence machine learning (AIML) based prediction of one or more channel instances to determine one or more predicted channel instances. The WTRU may perform one or more second measurements on the one or more predicted channel instances. The WTRU may determine an estimated prediction accuracy for each of the one or more predicted channel instances based on the one or more first measurements and the one or more second measurements. The WTRU may determine a compression ratio from the set of compression ratios for each of the one or more predicted channel instances based on the one or more first measurements and the determined estimated prediction accuracy. The WTRU may send compressed samples to the network in a report. The report may indicate the determined compression ratio for each of the one or more predicted channel instances.

The WTRU may determine the compressed samples by compressing the one or more predicted channel instances using the determined compression ratio associated with the respective predicted channel instance. A first compressed sample may be determined based on a first predicted channel instance of the one or more predicted channel instances and a first compression ratio. The first compressed sample may be determined based on the one or more first measurements. The configuration information may indicate one or more of a CSI-RS and CSI report configuration, a configuration of measurements for prediction accuracy estimation, a method and parameters for prediction accuracy estimation, an indicator to drop reporting of one or more CSI instances, or a reporting configuration. The one or more first measurements may include one or more of a coherence time, a doppler measurement, a time domain channel property (TDCP) with one or more configured delays, a WTRU speed, a received signal received power (RSRP), or a signal to interference noise ratio (SINR). The one or more second measurements may include one or more of out of distribution (OOD) detection, an anomalies rate, a distribution drift, a deviation between samples, a cross-correlation between the one or more predicted channel instances.

The estimated prediction accuracy for each of the one or more predicted channel instances may be determined by comparing differences between the one or more first measurements and the one or more second measurements with configured thresholds. The WTRU may calculate one or more key performance indicators and update a prediction accuracy mapping table based on the one or more second measurements. The estimated predication accuracy for each of the one or more predicted channel instances may be determined based on the updated prediction accuracy mapping table.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example channel state information (CSI) prediction plus compression.

FIG. 3 is a diagram illustrating an example artificial intelligence machine learning (AIML) based prediction plus compression of multiple CSI instances.

### DETAILED DESCRIPTION

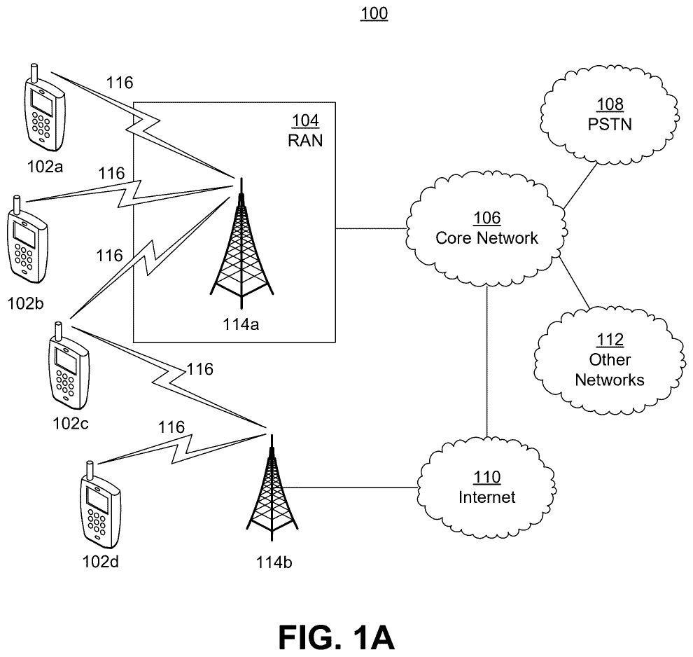

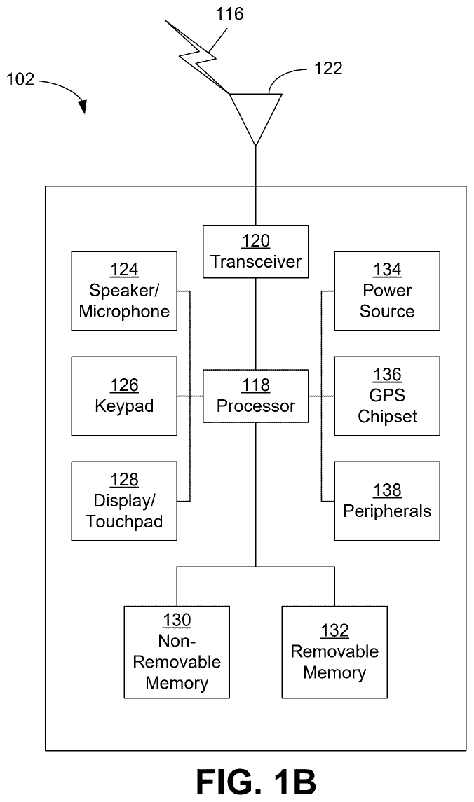

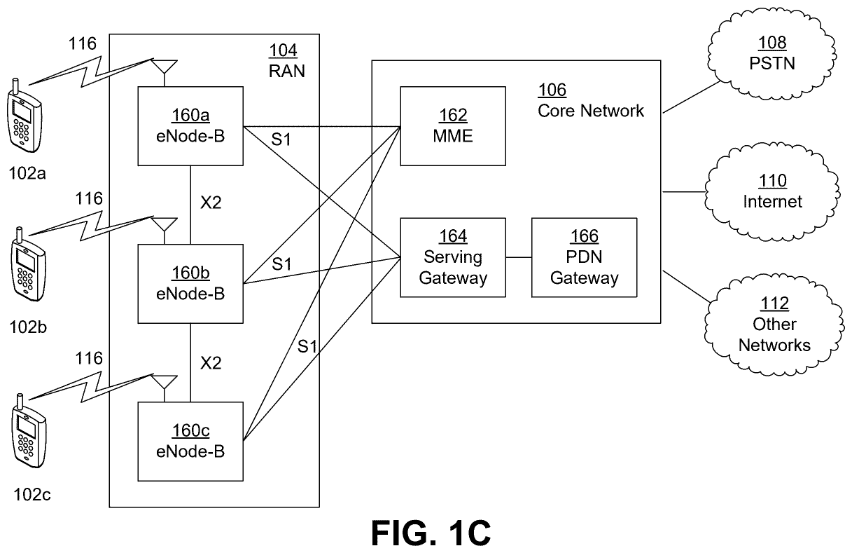

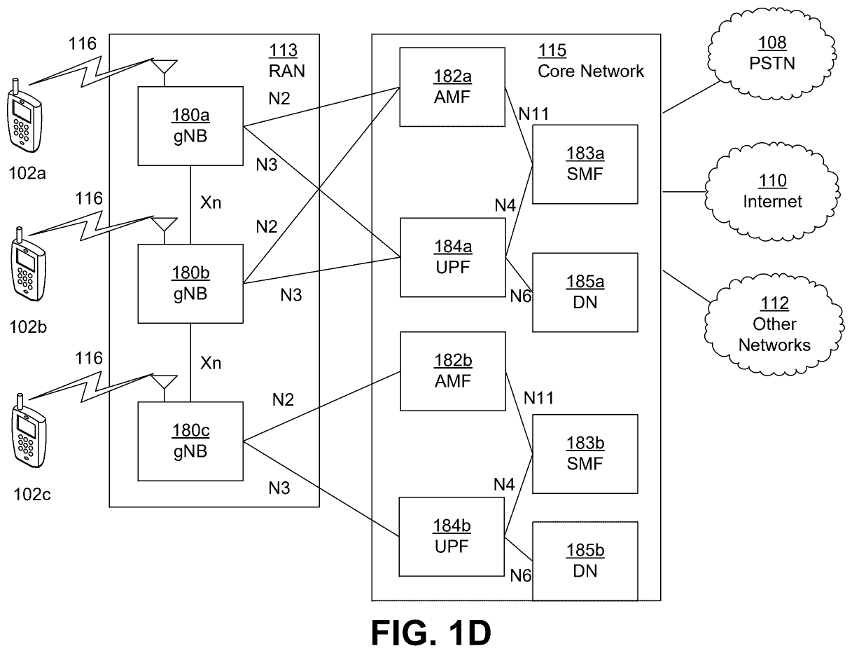

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI) machine learning (ML) based CSI enhancements may reduce CSI feedback reporting overhead. AI/ML based CSI prediction may mitigate channel aging and/or reduce the CSI feedback overhead.

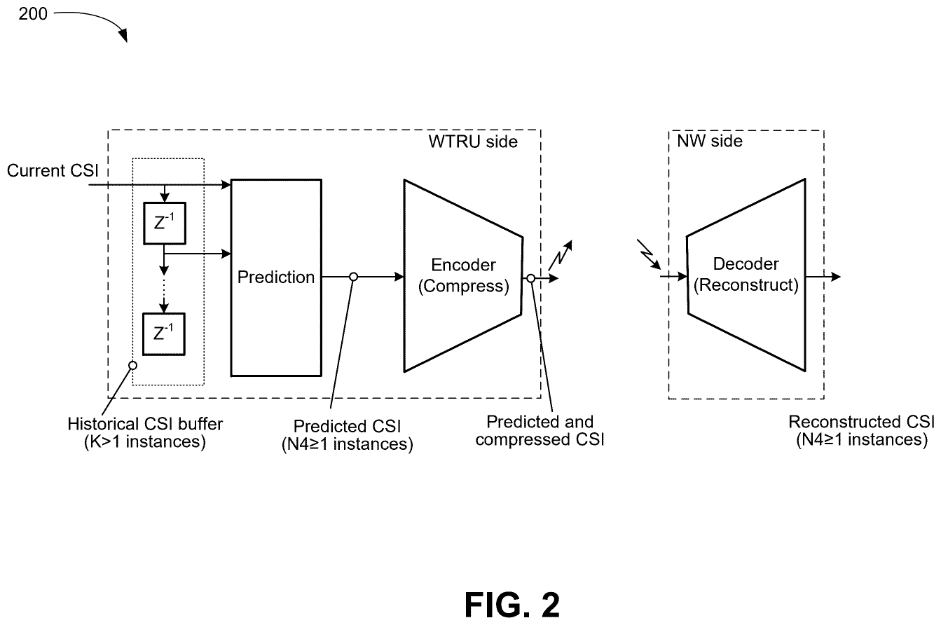

AI/ML based CSI compression may reduce the overhead with respect to legacy CSI feedback. FIG. 2 is a diagram illustrating an example channel state information (CSI) prediction plus compression 200. A way to improve the CSI performance is to perform AI/ML CSI prediction plus compression. In this approach, a first step processing uses multiple historical CSI instances to predict one or more future CSI instances; this is followed by a second step processing that compresses the one or more predicted future CSI instances, as shown in a high-level example in FIG. 2.

The CSI prediction step uses a single side AI/ML prediction model located at the WTRU (further referred to as the WTRU-sided model). The AI/ML prediction model may be based on RNN or LSTM model architectures to leverage the historical CSI instances (channel estimates based on the received CSI-RS) in the observation window to predict one or more future CSI instances, depending on the configured value of the prediction window size N4. The AI/ML-based CSI compression step typically uses a two-sided autoencoder (AE) model, where the encoder part (WTRU-side encoder) is located at the WTRU-side and performs the compression, while the decoder part, located at the NW-side (NW-side decoder), performs the reconstruction based on the received compressed CSI.

In the case where the CSI prediction AIML model is configured to predict multiple future CSI instances (N4>1), studies have shown that the accuracy of the predicted instances gradually degrades within the prediction window. The prediction accuracy degradation is caused by channel aging, where the latest predictions use older historical CSI samples from the observation window. This prediction accuracy degradation issue is significant for large prediction window size (N4).

For temporal-domain CSI prediction plus compression, the N4 predicted samples represent the inputs to the WTRU-side encoder for compression, thus the end-to-end (i.e., prediction plus compression) performance is penalized by the performance degradation of the latest predicted samples. Therefore, solutions are needed for performance improvement of Temporal Domain CSI prediction plus compression, when N4>1.

For systems using WTRU-side CSI prediction plus compression with separate prediction and compression models, and with compression of multiple predicted instances (N4>1), the following problems are addressed: for the compression step, how to leverage the temporal correlation of the N4 predicted CSI samples to reduce the CSI reconstruction error (due to compression), and how to determine optimal values of N4 compression ratios to meet target end-to-end CSI prediction plus compression performance for measured channel conditions and statistics and for given uplink resources constraints.

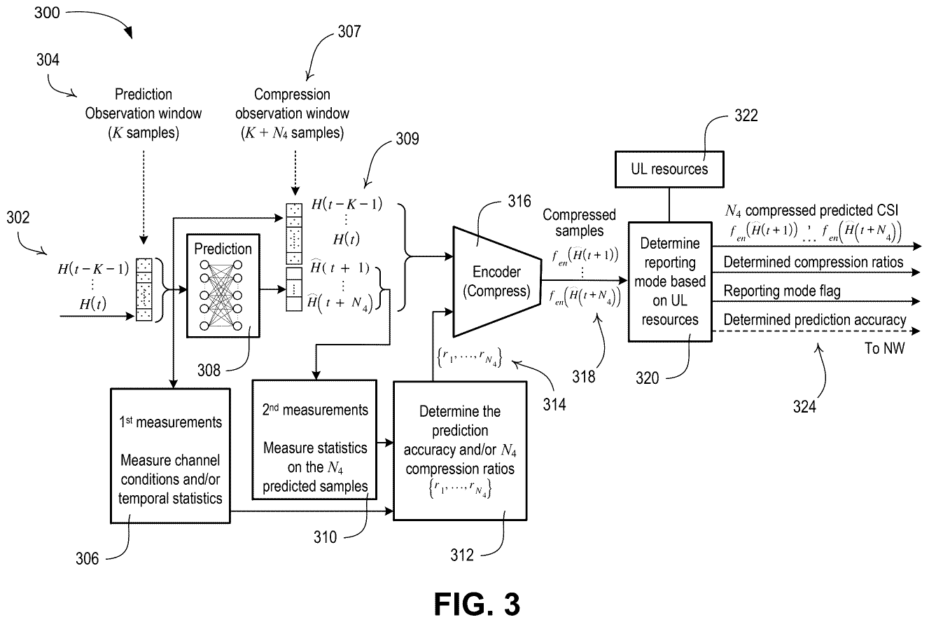

FIG. 3 is a diagram illustrating an example artificial intelligence machine learning (AIML) based prediction plus compression 300 of multiple CSI instances. A WTRU performing AIML-based prediction plus compression of multiple CSI instances (e.g., N4>1) may determine an accuracy of each predicted CSI instance and/or select a compression rate for each predicted CSI instance, for example, as a function of configured CSI performance threshold and/or determined prediction accuracy.

A WTRU may receive configuration information associated with temporal-domain CSI prediction and (e.g., plus) compression, for example, with multiple predicted instances. The configuration information may include one or more of the following. The configuration information may include a CSI-RS and CSI report configuration. The CSI-RS and CSI report configuration may include observation (e.g., duration and slot offset) and prediction windows (e.g., duration and slot offset) configuration. The configuration information may include a configuration of measurements for prediction accuracy estimation. For example, the configuration information may include a configuration of one or more first measurements performed on the estimated channel (e.g., in the observation window). The one or more first measurements may include statistical measurements (e.g., first order statistics) and/or channel conditions (e.g., WTRU speed, RSRP, SINR, TDCP, coherence time, Doppler). The configuration information may include a configuration of one or more second measurements performed on predicted channel instances (e.g., in the prediction window). The one or more second measurements may include statistical measurements (e.g., first order statistics, OOD, anomalies rate) and/or channel conditions (e.g., WTRU speed, RSRP, SINR, TDCP, coherence time, Doppler).

The configuration information may include a configuration of method and parameters for prediction accuracy estimation. The method and parameters for prediction accuracy estimation may be statistics based, or mapping table based. For statistics-based prediction accuracy estimation, the configuration information may indicate an out of distribution (OOD) detection configuration and/or one or more thresholds for differences between the one or more first measurements and the one or more second measurements. For mapping table-based prediction accuracy estimation, the configuration information may indicate a mapping table for estimated prediction accuracy as a function of channel measurements and sample index within the prediction window and/or a flag to enable updating the mapping table (e.g., based on actual prediction accuracy measurements).

The configuration information may include a set of (e.g., one or more) compression ratios to be used for compressing each of the N4 predicted CSI instances (e.g., min ratio, max ratio, etc.). The configuration information may include an indicator to drop reporting of one or more CSI instances (e.g., if prediction error is larger than threshold). The configuration information may include a reporting configuration (e.g., configured reporting modes and criteria for selection).

The WTRU may receive CSI-RS. The WTRU may perform channel estimation 302 and/or store K estimated channel samples in an observation window 304 (e.g., a prediction observation window) based on the received CSI-RS, for example, according to the configuration information.

The WTRU may perform one or more first measurements 306 on the K channel samples. The one or more first measurements may include first order statistics and/or channel conditions (e.g., a coherence time, a doppler measurement, a TDCP with one or more configured delays, a WTRU speed, a RSRP, a SINR, etc.).

The WTRU may perform AIML-based prediction 308 of one or more channel instances (e.g., N4 channel instances), for example, in a compression observation window 307 (e.g., K+N4 samples). For example, the WTRU may determine one or more predicted channel instances 309 (e.g., N4 predicted channel instances) using the AIML-based prediction 308. The WTRU may perform one or more second measurements 310 on the one or more predicted channel instances. The one or more second measurements 310 may include one or more of first order statistics, OOD detection, an anomalies rate, a distribution drift, a deviation between the first and N4-th samples, a cross-correlation between predicted channel instances, etc. The WTRU may calculate one or more KPIs and/or update the prediction accuracy mapping table (e.g., when configured)

The WTRU determines an estimated prediction accuracy 312 for each of the one or more predicted channel instances, for example, based on the configured method and/or the one or more first and one or more second measurements. For example, the determination of the estimated prediction accuracy 312 may be statistics based (e.g., as a function of the first and second measurements). For example, the determination of the estimated prediction accuracy 312 may be based on differences between the one or more first measurements and the one or more second measurements. The WTRU may compare the difference(s) with one or more configured thresholds. Additionally or alternatively, the determination of the estimated prediction accuracy 312 may be based on OOD detection of the one or more predicted channel instances of the second set with respect to the K samples in the first set. Additionally or alternatively, the determination of the estimated prediction accuracy 312 may be based on the mapping table.

The WTRU may determine a compression ratio 314 for each of the one or more predicted channel instances (e.g., N4 compression ratios). The compression ratio(s) 314 may be determined based on configured prediction and compression performance requirements, one or more first measurements, and/or the estimated prediction accuracy. For example, the compression ratio(s) 314 may be determined based on the one or more first measurements and the estimated prediction accuracy.

The WTRU may determine N4 compressed samples 318 by compressing the one or more predicted channel instances using the determined compression ratio associated with the respective predicted channel instance. For example, the WTRU may use an encoder 316 to compress the one or more predicted channel instances. For example, the WTRU may determine a first compressed sample based on a first predicted channel instance (e.g., of the N4 predicted CSI instances) and a first compression ratio (e.g., of the N4 compression ratios 314). In another example, the WTRU may determine a first compressed sample based one or more predicted channel instances, a first compression ratio, and one or more measured sample of the K channel samples.

The WTRU may determine a reporting mode 320 as a function of the N4 determined compression ratios and/or one or more available UL resources 322. The reporting mode 320 may include a first mode (e.g., Mode 1) associated with joint transmission of the N4 compressed samples, a second mode (e.g., Mode 2) associated with separate transmission of the N4 compressed samples, a third mode (e.g., Mode 3) associated with the first mode plus measured prediction performance, and a fourth mode (e.g., Mode 4) associated with the second mode plus measured prediction performance.

The WTRU may send the compressed samples 318 to the network in a report 324. For example, the WTRU may report (e.g., the report 324 may include) the N4 compressed samples 318 (e.g., possibly as a function the determined reporting mode). The report 324 may include one or more of the determined N4 compression ratios 314, a determined reporting mode 326 (e.g., a 2-bits flag), or a determined estimated prediction accuracy 312.

Determination of compression ratios for temporal-domain CSI prediction plus compression with multiple predicted instances may improve reconstruction performance at a decoder and/or optimize reporting overhead. For example, by leveraging the temporal correlation of the predicted samples at the input of the compression block, and by determining an estimate of the prediction accuracy of N4 CSI samples, adaptive determination of N4 compression ratios may be enabled, thus improving reconstruction performance at the decoder, while optimizing the reporting overhead.

Determination of compression ratios for temporal-domain CSI prediction plus compression with multiple predicted instances may be provided herein. For example, a WTRU may be configured for the determination of multiple compression ratios. A WTRU with AI/ML CSI processing capability may receive configuration information associated with (e.g., for) temporal-domain CSI prediction plus compression with multiple predicted instances. The configuration may include observation and prediction window configuration, configuration of measurements for prediction accuracy estimation, method and parameters for prediction accuracy estimation, compression ratios for the multiple predicted CSI instances, CSI performance requirements and reporting configuration.

The WTRU may configure an observation window and/or a prediction window. The WTRU may receive a configuration (e.g., via the configuration information) for the observation window. The observation window may refer to the historical samples (e.g., CSI samples) at the input of the prediction block. The configuration for the observation window may include a reference signal configuration (e.g., CSI-RS configuration) for CSI measurement. The reference signal may be configured to be periodic, semi-persistent, or aperiodic. The configuration for the observation window may include a number of historical samples (K) to be stored in the observation window. The configuration for the observation window may include a period between consecutive samples in the observation window. The configuration for the observation window may include an observation window duration (e.g., in slots).

The WTRU may receive a configuration (e.g., via the configuration information) for the prediction window. The prediction window may refer to a number of future CSI samples that need to be predicted and reported to the NW. The configuration of the prediction window may include one or more of a number of predicted CSI instances (N4), a period between consecutive predicted CSI instances, or a time duration between the first predicted CSI instance and the most recent CSI instance in the observation window. In another example, the WTRU may receive a configuration (e.g., via the configuration information) for the time duration between the end of the observation window and the start of the prediction window.

The WTRU may configure the measurements for prediction accuracy estimation. The WTRU may receive a configuration (e.g., via the configuration information) for prediction accuracy estimation. The measurements may include a first set of measurements performed on the estimated channel (e.g., on the CSI samples in the observation window) and a second set of measurements performed on the predicted channel (e.g., on the CSI samples in the prediction window). The configuration of the first set of measurements (e.g., measurements on the data in the observation window) may include one or more of the following. The configuration of the first set of measurements may include configuration of one or more statistical measurements. The statistical measurements may include first or second order statistics for the elements of the raw channel matrix or the eigenvectors (EV) of the channel matrix. The statistical measurements may include a distribution (e.g., PDF or CDF) of the elements of the raw channel/EV, where the configuration may include minimum, maximum value and step size or resolution. The statistical measurements may include a frequency or a periodicity of resetting the statistical measurements. For example, the WTRU may be configured to reset the statistical measurements at the start of each observation window. In another example, the WTRU may be configured to reset the statistical measurements every N (N>1) observation windows.

The configuration of the first set of measurements may include one or more configuration channel conditions measurements (e.g., such as the WTRU speed, a RSRP, a SINR, a TDCP, a coherence time of the channel, a coherence bandwidth of the channel, a Doppler spread, etc.). The configuration of the first set of measurements may include a configuration for wideband or sub-band measurements. For example, the WTRU may be configured to collect wideband measurements, e.g. for the entire allocated bandwidth (or bandwidth part BWP), or it may be configured to collect statistical measurements per sub-band, for example using the configured sub-band size.

The configuration of the second set of measurements may include one or more of a configuration of statistical measurements or a configuration of channel conditions measurements (e.g., such as WTRU speed, RSRP, SINR, TDCP, coherence time, doppler spread, etc.). The configuration of statistical measurements may include metrics such as first order and/or second order statistics for the values of the raw channel or the eigenvectors of the channel matrix. The configuration of statistical measurements may include a configuration for out-of-distribution (OOD) measurements (e.g., of the samples in the prediction window with respect to the distribution of the samples in the observation window). The configured OOD measurement parameters may include a parameter for energy score calculation and/or an energy score threshold for OOD detection. The configuration of statistical measurements may include a configuration of dataset similarity metrics. The WTRU may be configured with metrics to determine the similarity between samples in the prediction window with respect to the samples in the observation window, where the similarity metrics may include geometric distances (e.g., cosine similarity, Euclidian distance between clusters, centroids, etc.), statistical distances (e.g., Wasserstein, total variation, KL, etc.), and/or manifold/subspace distances (e.g., Grassmann). The configuration of statistical measurements may include a configuration for measuring anomaly rate (e.g., anomaly rate for the elements of the CSI instances in the prediction window relative to the distribution of the elements of the CSI instances in the observation window) and/or a threshold for anomaly detection. The anomaly detection threshold may be an absolute threshold (e.g., for the magnitude of the elements of the CSI raw channel/EV). The anomaly detection threshold may be a relative threshold (e.g., as a fraction of the maximum magnitude of the elements of the CSI raw channel/EV in the observation window).

The WTRU may receive configuration information associated with (e.g., a configuration for) the method and parameters for prediction accuracy estimation. The configuration information associated with the method and parameters for prediction accuracy estimation may include a prediction accuracy estimation method. For example, the prediction accuracy estimation method may be based on statistical first (e.g., observation window) and second (e.g., prediction window) measurements, based on channel conditions measurements performed for the observation window and the prediction window, and/or based on a mapping table/mapping function.

For a statistics-based prediction accuracy estimation method, one or more of the following may apply. The WTRU may be configured with a set of thresholds for OOD detection, and a set of thresholds for the OOD occurrence rate, based on which the WTRU may estimate levels or scores for the prediction accuracy. For example, when the WTRU is configured with a single OOD detection threshold, the WTRU may estimate two levels of prediction accuracy, e.g. low and high. In this example, the WTRU uses the single OOD detection threshold to determine samples of the prediction window which are OOD with respect to the observation window. The WTRU may estimate the prediction accuracy as “low” when the relative number of OOD samples exceeds the configured OOD occurrence rate threshold. In another example, when the WTRU is configured with two OOD detection thresholds, the WTRU may determine three levels of prediction accuracy, e.g. low, medium and high. In yet another example, when the WTRU is configured with N OOD detection thresholds, the WTRU may determine N+1 levels of prediction accuracy. The WTRU may be configured with thresholds corresponding to the configured dataset similarity metrics, based on which the WTRU may estimate the prediction accuracy (or accuracy levels). For example, when the WTRU is configured to perform dataset similarity measurements between the samples in the prediction window and the samples in the observation window, the WTRU may estimate the prediction accuracy as “high” when the measured distance (e.g., Wasserstein distance) is smaller than the configured threshold.

For a channel conditions-based prediction accuracy estimation method, one or more of the following may apply. The WTRU may receive configuration for one or more thresholds for the differences between channel metrics in the prediction window (e.g., the second set of measurements) and channel metrics in the observation window (e.g., the first set of measurements). For example, the WTRU may receive configuration for thresholds for the difference between the TDCP/RSRP/SINR/coherence time measured on the prediction window and the TDCP/RSRP/SINR/coherence time measured on the observation window. The WTRU may estimate the prediction accuracy as “high”, for example, when the measured differences are below the configured thresholds for most or for all configured metrics.

For a mapping table/mapping function prediction accuracy estimation method, one or more of the following may apply. The WTRU may estimate the prediction accuracy as a function of the measured channel conditions (e.g., such as WTRU speed, coherence time, TDCP, SINR), observation window duration, delay between the end of the observation window and start of the prediction window, time period between consecutive CSI instances (e.g., in the observation widow, and in the prediction window) and index of the predicted sample within the observation window. The WTRU may receive an indication of the mapping function to use, for example when the function is pre-defined. The WTRU may estimate the prediction accuracy based on a first mapping table, where the first mapping table is a prediction accuracy mapping table that provides the prediction accuracy as a function of channel conditions. In a solution, the first mapping table (e.g., the prediction accuracy mapping table) may be indexed by the ratio between the channel coherence time and the period between consecutive CSI instances and by the measured SNR/SINR and provide the corresponding prediction accuracy. The first mapping table may provide an estimate of the prediction accuracy for each CSI instance of the N₄ predicted CSI instances. The WTRU may receive an indication of the first mapping table to use, for example when the prediction accuracy mapping table is pre-defined. The first mapping table may be a prediction error mapping table that provides the prediction error as a function of measured channel conditions and the location of each predicted CSI instance within the prediction window. The WTRU may receive configuration to enable updating the first mapping table, for example based on the actual prediction accuracy measurements.

The WTRU may receive configuration information associated with (e.g., a configuration for) a set of compression ratios to be used for compressing the N₄ predicted CSI instances. The configuration information associated with the set of compression ratios may include a minimum compression ratio, a maximum compression ratio, a second mapping table, and/or a list of compression ratios for each predicted CSI instance in the prediction window. In one example, the list of compression ratios to select from may be the same across all samples in the prediction window. In another example, there may be different lists of compression ratios for each index in the prediction window, e.g. to allow higher compression ratios for instances closer to the start of the prediction window, and lower compression ratios for instances closer to the end of the prediction window. The second mapping table may be a compression mapping table that provides the compression ratio as a function of the estimated prediction accuracy and the configured overall CSI performance requirements. In examples, the second mapping table (compression ratio mapping table) may be configured separately from the first mapping table (prediction accuracy mapping table). In another solution, the compression rate may be included, jointly with the prediction accuracy, in a single (e.g., joint) mapping table, for example in the first mapping table.

The WTRU may receive configuration information associated with (e.g., a configuration for) the overall CSI performance requirements, that includes the prediction performance (e.g., prediction accuracy) and the compression performance (e.g., reconstruction error). For example, the overall CSI performance requirements may be configured as a SGCS threshold and/or a NMSE threshold, where the SGCS or NMSE is measured at the output of the NW-side decoder (e.g., CSI reconstruction).

The WTRU may receive configuration information associated with (e.g., a configuration for) reporting. The WTRU may be configured to drop reporting of one or more CSI instances, for example when the estimated prediction accuracy exceeds the configured overall CSI performance threshold.

The WTRU may receive configuration information associated with (e.g., a configuration for) CSI reporting. The configuration information associated with CSI reporting may include an indicator for the reporting mode. The reporting mode may be a first mode (e.g., Mode 1) associated with joint reporting of the N₄ predicted and compressed samples, a second mode (e.g., Mode 2) associated with separate reporting of each of the N₄ predicted and compressed samples, a third mode (e.g., Mode 3) associated with joint reporting of the N₄ predicted and compressed samples and reporting of the measured prediction accuracy, or a fourth mode (e.g., Mode 4) associated with separate reporting of each of the N₄ predicted and compressed samples and reporting of the measured prediction accuracy. The configuration information associated with CSI reporting may include an indicator to enable autonomous WTRU selection of the reporting mode. For example, the WTRU may select Mode 1 or Mode 2 based on the N₄ determined compression ratios and the available UL resources. The WTRU may select Mode 3 or Mode 4 as a function of the N₄ determined compression ratios and the available UL resources, for example, when the WTRU is configured to report the measured prediction accuracy (e.g., for model monitoring or when updating the mapping table is enabled). The configuration information associated with CSI reporting may include resources for CSI reporting, where reporting may be configured as periodic, semi-persistent or aperiodic. The configuration information associated with CSI reporting may include resources for reporting the estimated prediction accuracy. The WTRU may report the estimated prediction accuracy for one or more of the N₄ CSI instances, for example, when the estimated prediction accuracy for any of the N₄ CSI instances exceed the configured overall CSI performance threshold.

A WTRU may perform measurements on the channel estimates and on the multiple predicted CSI instances. The WTRU may receive CSI-RS within a configured observation window. The WTRU may perform channel estimation on the received CSI-RS. The WTRU may store one or more (e.g., K) channel samples. The WTRU may perform one or more first measurements on the one or more (e.g., K) channel samples in the observation window. The WTRU may compute one or more statistical measurements on the K channel samples (e.g., such as the mean, variance, standard deviation, median, interquartile range, skewness etc.). The WTRU may compute one or more channel conditions (e.g., such as the coherence time, doppler spread, TDCP with one or more configured delays, sample & hold value for successive channel samples within the observation window, the WTRU speed, RSRP, SINR, etc.).

The WTRU may perform prediction (e.g., AIML-based prediction) of N4 Channel Instances, ƒ_{θ}(Hₜ, Hₜ₋₁, . . . , H_{t-K-1})=Ĥₜ₊₁,. . . , Ĥ_{t+N4}, where, ƒ_{θ}(·) is the configured prediction model (e.g., AI/ML model). The configured prediction (e.g., AIML model) may use the K channel samples in the observation window as an input and may output N4 predicted channel instances.

The WTRU may perform one or more second measurements on the N4 predicted channel instances. The WTRU may compute one or more of the following. The WTRU may compute one or more statistical measurements. The WTRU may compute summary statistics on the N4 predicted channel instances (e.g., such as mean, variance, standard deviation, skewness, inter-quartile range, median etc.). The WTRU may compute these statistics for the raw channel and/or eigenvectors of the channel matrix. The WTRU may compute one or more similarity measurements. For example, the WTRU may compute one or more similarity metrics between the samples in the predicted window and observation widow. The WTRU may compute the similarity metrics between the predicted window and observation window relative to a third distribution (e.g. training distribution). The similarity metrics may be geometrical (e.g., Euclidean distance, cosine similarity), statistical (e.g., KL-divergence, Wasserstein) and/or manifold/subspace distances (e.g., Grassman). The WTRU may compute one or more temporal properties. The WTRU may compute temporal measurements of the predicted samples such as NMSE/SGCS/MSE between successive samples, cross-correlation between predicted sample instances, and/or the deviation between the first and N4th samples. The WTRU may compute one or more distribution measurements. The WTRU may compute distribution drift or perform out of distribution (OOD) detection for one or more predicted samples. The WTRU may compute one or more anomaly rate measurements. The WTRU may compute the number of times a predicted sample is an anomaly within the measurement window.

A WTRU configured to perform performance monitoring may receive ground-truth samples for the prediction window. The WTRU may compute the actual prediction accuracy KPI (e.g., NMSE, SGCS, MSE, MAE etc). The WTRU may update one or more rows in the mapping table based on the actual prediction accuracy. For example, if the mapping table maps measured SINR to a KPI then the WTRU may update the KPI associated with that SINR in the mapping table.

A WTRU may be configured to determine a prediction accuracy estimate. The WTRU may determine an estimate of the prediction accuracy/error for each of the N4 predicted CSI samples, for example, based on the configured method, the one or more first measurements, and/or the one or more second measurements. For example, the WTRU may determine the prediction accuracy estimate based on one or a combination of statistical measurements of the observation window and prediction window, measured channel conditions, and/or a configured first mapping table.

The WTRU determination of an estimate of the prediction accuracy/error may be statistic based, for example, as a function of the first and second measurements. For example, the WTRU may calculate the difference between one or more first measurements and one or more second measurements, for example based on first order statistics (e.g., the mean, standard deviation, variance, median, range, interquartile range), channel conditions (e.g., SINR, RSRP, TDCP, coherence time, coherence bandwidth, Doppler spread). The WTRU may be configured to collect wideband measurements, e.g., for the entire allocated bandwidth (or bandwidth part BWP). Additionally or alternatively, the WTRU may be configured to collect statistical measurements per sub-band, for example, using the configured sub-band size.

The WTRU may use dataset similarity metrics to determine the difference/similarity between the N4 samples in the prediction window and the K samples in the observation window, for example, geometrical distances (e.g., cosine similarity, Euclidean distance between clusters, centroids, etc.), statistical distances (e.g., Wasserstein distance, total variation, KL divergence, etc.), and/or manifold/subspace distances (e.g., Grassmann). The WTRU may use second order statistics, for example, the cross-correlation between each of the N4 predicted CSI samples and one or more of the K samples within the observation window. The WTRU may compare the calculated absolute differences with configured thresholds. For example, the WTRU may be configured with different thresholds, each associated to a statistical metric. In another example, The WTRU may be configured with thresholds per metric, for each WTRU speed range and/or TDCP range for example, wherein thresholds for each metric may differ as the channel is less corelated if the WTRU speed increases (e.g., higher thresholds may be tolerated for less correlated channels while lower thresholds may be configured for more correlated channels).

The WTRU may determine an estimate of the prediction accuracy/error of the N4 predicted samples based on distribution drift. For example the WTRU may calculate the distance (e.g., absolute distance) between the distribution of the K samples in the observation window and the N4 samples in the prediction window. For example, such distance may be based on the PDF and/or CDF of the two distributions, and/or based on the PDF/CDF of the measured RSRP of the channel samples.

The WTRU may determine an estimate of the prediction accuracy/error for each of the N4 predicted CSI samples as a function of OOD detection. For example, the WTRU may determine an OOD score or probability of the predicted N4 samples with respect to the K samples in the observation window. The WTRU may perform OOD detection in a sequential manner, for example, for each of the N4 samples, the WTRU determines a OOD score with respect to the distribution of the K samples within the observation window. The WTRU may determine an OOD score of the entire N4 predicted samples as a distribution, with respect to the distribution of the K samples in the observation window. The OOD detection may be applied using different approaches/techniques according to the OOD detection configuration, for example, AIML-based (e.g., Autoencoder), optimization algorithms based, and/or statistics-based (e.g., anomalies rate, Kullback-Leibler (KL) divergence, Total Variation, Wasserstein distance, etc.).

The WTRU may use a configured first mapping table for the determination of an estimate of the prediction accuracy/error for the N4 predicted samples. For example, the WTRU may use a first mapping table, for example, as a function of channel measurements (e.g., first measurements and/or second measurements), and as a function of sample index within the prediction window. For example, the WTRU may determine an estimate of the prediction accuracy based on a set of first measurements and second measurements, and accordingly finding an index in the first mapping table matching measurements (e.g., ranges of values for measurement metric) with a prediction accuracy estimate or prediction error estimate. For example, for each of the N4 predicted samples, the WTRU may match/determine a prediction accuracy/error as a function of the performed measurements, including channel conditions. In this example, the first mapping table may have different indexes for each of the N4 prediction instances, wherein each index maps between one or more measurement range(s) and an estimate of the prediction accuracy and/or prediction error. The WTRU may receive in the configuration a first mapping table update/fine-tuning flag, wherein the WTRU may update/fine-tune the first mapping table accordingly to improve the determination of a prediction estimate for the subsequent prediction's occasions. For example, the WTRU may receive (e.g., also receive) in the configuration information a performance monitoring flag, allowing the WTRU to monitor the performance of the performed N4 predictions based on actual prediction accuracy measurements. For example, WTRU may compare the determined prediction accuracy/error estimate for each of the N4 samples, with the exact prediction accuracy/error upon receiving one or more next CSI-RS for extracting the ground-truths associated to the predicted N4 samples.

Estimates of the prediction performance may be based on an accuracy metric (e.g., accuracy, SGCS, precision), or based on error metrics (e.g., MSE or NMSE). The predictions estimates may be determined as confidence levels (e.g., {“Excellent”, “Very good”, “Good”, “Moderate”, “Poor”, “Very poor”}), probabilities (e.g., values between 0 and 1), scores, and/or indexes (e.g., mapping index to a row of the first mapping table). The WTRU may use one or a combination of the methods mentioned above to determine an estimate of the prediction accuracy/error of the N4 predicted CSI samples.

The WTRU may determine one or more compression ratios to use to compress one or more predicted CSI samples based on one or more of the following. The WTRU may determine N4 compression ratios for N4 predicted CSI samples. The WTRU may determine one or more compression ratios based on a prediction accuracy of predicted CSI samples. The WTRU may determine a compression ratio for a predicted CSI sample based on the estimated prediction accuracy of the predicted CSI sample. For example, the WTRU may use a second mapping table, e.g., configured by the NW, to determine the compression ratio for a predicted CSI sample (out of N4 predicted samples) for a given prediction accuracy. The second mapping table may provide a compression ratio corresponding to a prediction accuracy. For example, the WTRU may use a second mapping table that provide a range of compression ratios corresponding to a estimated prediction accuracy. The WTRU may select a compression ratio (e.g., for each of the N4 predicted samples) as a function of the configured performance requirements. For example, if performance requirements prioritize reconstruction performance over overhead, then the WTRU may select the lowest compression ratio within the selected range of compression ratios. Conversely, if performance requirements prioritize the overhead, then the WTRU may select the highest compression ratio within the selected range. In another example, the WTRU may select an intermediate compression ratio within the selected range if the configured performance requirements are balanced between performance and overhead.

The WTRU may determine one or more compression ratios based on an estimated reconstruction error. The WTRU may determine a compression ratio for a predicted CSI sample based on estimated reconstruction error, e.g., configured by the NW. For example, the WTRU may compute the total estimated reconstruction error based on the prediction accuracy and compression ratio. The WTRU may determine an estimated prediction error based on the prediction accuracy, for example, estimated prediction error in terms of intermediate KPI, e.g., SGCS or NMSE. The WTRU may determine an estimated prediction error as a function of the determined prediction accuracy in terms of confidence level or uncertainty, e.g., Low, Medium, High. The WTRU may determine an estimated compression error based on a compression ratio, e.g., compression error in terms of intermediate KPI, e.g., SGCS or NMSE, or in terms of a confidence level or uncertainty. The WTRU may compute the total estimated reconstruction error based on the estimated prediction error and estimated compression error. The WTRU may determine a compression ratio for a predicted CSI sample based on the total estimated reconstruction error, e.g., the WTRU may select the lowest compression ratio so that the total estimated reconstruction error is below a configured threshold on total estimated reconstruction error. For example, the WTRU may be configured with the same threshold on total estimated reconstruction error for each prediction instance. The WTRU may be configured with different thresholds on total estimated reconstruction error for each prediction instance. The WTRU may be configured with a single threshold on total reconstruction error for all predicted CSI samples.

The WTRU may determine one or more compression ratios based on one or more measurements. The WTRU may determine the compression ratio based on the one or more measurements using the measured CSI and the predicted CSI. For example, the WTRU may compute out-of-distribution score for predicted CSI sample. The WTRU may determine a compression ratio based on the computed OOD score for the predicted sample. The WTRU may select a lower compression ratio for a higher OOD score. The WTRU may select a higher compression ratio for a lower OOD score. The WTRU may compute a difference of statistics on measured CSI and predicted CSI. For example, the WTRU may compute the absolute difference of mean, variance, distribution, median, range, interquartile range, channel conditions (e.g., SINR, RSRP), TDCP. The WTRU may determine a compression ratio for a predicted CSI sample based on the computed difference in statistics. The WTRU may determine a higher compression ratio if the difference between the statistics is lower than a threshold. The WTRU may determine a lower compression ratio of the difference between the statistics is higher than a threshold. The WTRU may determine the lower/higher compression ratio if the WTRU speed is above/below a higher/lower threshold for the supported AIML-based CSI compression model.

The WTRU may determine one or more compression ratios based on a maximum and/or a minimum compression ratio. The WTRU may determine a compression ratio based on the configured minimum and maximum compression ratio. For example, if the determined compression ratio is below a configured minimum compression ratio, then the WTRU may set the compression ratio as the minimum compression ratio. If the determined compression ratio is above the maximum compression ratio, then the WTRU may set the compression ratio as the maximum compression ratio.

The WTRU may compress the CSI samples based on the determined compression ratios. The WTRU may use one of the following options for compression. The WTRU may determine a compressed sample based on a first predicted CSI instance (e.g., of the N4 predicted CSI instances) and/or a first compression ratio (e.g., of the N4 compression ratios). The WTRU may determine to use this option based on the correlation between measured CSI and predicted CSI. For example, if the correlation between predicted CSI and measured CSI is lower than a threshold, then the WTRU may select this option.

The WTRU may determine a first compressed sample based one or more predicted CSI instance(s), a first compression ratio, and/or one or more measured channel samples. For example, the WTRU may determine to use this option based on the correlation between measured CSI and predicted CSI. If the correlation between predicted CSI and measured CSI is higher than a threshold, then the WTRU may select this option. The WTRU may gradually increase the number of measured channel samples at the input of the compression model. For example, the WTRU may extend the input buffer to the compression model by concatenating the K samples of the observation window to the N4 predicted samples, for example, to improve the compression (e.g., by adding more common information for temporal compression, and/or by leveraging more temporal correlation for TSF-based compression) and/or reconstruction accuracy. The WTRU may additionally add gradually one or more of the predicted samples to the temporal compression block for the compression of one or more of N4-1 samples.

When the WTRU is configured by the NW with multiple available CSI reporting modes (e.g., including one or more of the following: Mode 1: joint reporting of the N₄ predicted and compressed samples, Mode 2: Separate reporting of each of the N₄ predicted and compressed samples, Mode 3: joint reporting of the N₄ predicted and compressed samples and reporting of the measured prediction accuracy, and Mode 4: Separate reporting of each of the N₄ predicted and compressed samples and reporting of the measured prediction accuracy). And, when the WTRU is enabled to have the autonomous reporting mode selection, the WTRU may determine its reporting mode based on one or more of the factors. In an example, the WTRU may select either the joint transmission or the separate transmission, based on the determined compression ratios, the number of the samples dropped due to the estimated prediction/reconstruction error, the available UL resources, etc. In another example, the WTRU may report the prediction performance as requested by the NW for model monitoring and/or any of the mapping table update. In another example, the WTRU reports the prediction accuracy for one or more of the N4 CSI instances whenever they are lower than a pre-defined threshold. The WTRU may report the determined reporting mode to the NW, for example, using several bits that are sufficient to represent every mode.

The WTRU may be configured or determine to report one or more of the following: one or more metrics from the one or more first measurements, one or more metrics from the one or more second measurements, the estimated prediction accuracy of the N4 predicted samples, and/or an updated mapping table.

For the purpose of the prediction model monitoring, the prediction accuracy mapping table update, etc., the WTRU may be configured or determine to report one or more of the following: the estimated prediction accuracy of the N4 predicted samples and/or the N4 (or less, if one or more samples are dropped due to the corresponding estimated prediction errors are higher than a certain threshold) compression ratios. For example, if the WTRU drops one or more samples, the WTRU may include in the report an indication of the time instant(s) corresponding to the reported compressed sample(s) (e.g., TTI(s), index(es), timestamp(s)). The WTRU may alternatively report an indication of the dropped sample(s) by including in the report, for example, timestamp(s) or index(es) corresponding to one or more dropped sample(s). The WTRU may be configured to report the estimated total reconstruction error of the N4 (or less) compressed samples, for example, for the purpose of the compression model monitoring, the compression ratio mapping table update, etc.

The WTRU may be configured to perform CSI reporting periodically, semi-persistently, or aperiodically. The WTRU may be configured with the UL resources to report the compressed CSI samples and the other parameters. In an example, the WTRU may be configured to report the compressed samples in UCI transmitted through PUCCH or PUSCH. The other parameters, such as the reporting mode, the estimated prediction accuracy, the compression ratios, etc., may be configured with the same or different L1/L2 or higher layer UL resources than the compressed samples. In an example, the WTRU may be configured to report the reporting mode in UCI and to report the estimated prediction accuracy in MAC CE.

A WTRU may receive configuration for (e.g., configuration information associated with) temporal-domain CSI prediction plus compression with multiple predicted instances. The received configuration may include one or more of the following. The received configuration may include a CSI-RS and CSI report configuration, including observation (e.g., duration and slot offset) and prediction windows (e.g., duration and slot offset) configuration. The received configuration may include a configuration of measurements (e.g., first and/or second measurements) for prediction accuracy estimation. The first measurements may be performed on the estimated channel (e.g., in the observation window). For example, the first measurements may include statistical measurements (e.g., first order statistics) and/or channel conditions (e.g., WTRU speed, RSRP, SINR, TDCP, coherence time, Doppler). The second measurements may be performed on predicted channel instances (e.g., in the prediction window). The second measurements may include statistical measurements (e.g., first order statistics, OOD, anomalies rate) and/or channel conditions (e.g., WTRU speed, RSRP, SINR, TDCP, coherence time, Doppler). The received configuration may include a configuration of method and parameters for prediction accuracy estimation. For example, the received configuration may indicate a statistics based prediction accuracy estimation or a mapping table based prediction accuracy estimation. For statistics-based prediction accuracy estimation, the configuration information may include thresholds for differences between the first measurements and the second measurements, and/or an OOD detection configuration. For mapping table-based prediction accuracy estimation, the configuration information may include a mapping table for estimated prediction accuracy (e.g., as a function of channel measurements and sample index within the prediction window) and/or a flag to enable updating the mapping table (e.g., based on actual prediction accuracy measurements).

The received configuration information may include a set of compression ratios to be used for compressing each of the N4 predicted CSI instances (e.g., min ratio, max ratio, etc.). The received configuration information may include an indicator to drop reporting of one or more CSI instances (e.g., if prediction error is larger than threshold). The received configuration information may include a reporting configuration—e.g., configured reporting modes and criteria for selection.

The WTRU may receive CSI-RS in an observation window, according to the configuration. The WTRU may perform channel estimation and/or store K channel samples based on the received CSI-RS.

The WTRU may perform one or more first measurements on the K channel samples. The one or more first measurements may include one or more first order statistics and/or one or more channel conditions (e.g., coherence time, Doppler, TDCP with one or more configured delays, WTRU speed, RSRP, SINR).

The WTRU may perform AIML-based prediction of N4 channel instances. The WTRU may perform one or more second measurements on the N4 predicted channel instances. The one or more second measurements may include one or more first order statistics, an OOD detection, an anomalies rate, a distribution drift, a deviation between the 1^{st} and N4-th samples, and/or a cross-correlation between predicted channel instances. The WTRU may calculate KPIs and may update the prediction accuracy mapping table.

The WTRU may determine an estimate of the prediction accuracy for each of the N4 predicted samples, for example, based on the configured method and the one or more first and one or more second measurements. The estimate of the prediction accuracy may be statistics based (e.g., as a function of the first and second measurements). For example, the estimate of the prediction accuracy may be based on differences between the one or more first measurements and the one or more second measurements and/or comparing the difference with configured thresholds. The estimate of the prediction accuracy may be based on OOD detection of the N4 samples of the second set with respect to the K samples in the first set. The estimate of the prediction accuracy may be based on the mapping table.

The WTRU may determine N4 compression ratios, as a function of configured prediction and compression performance requirements, one or more first measurements, and/or the estimated prediction accuracy.

The WTRU may determine N4 compressed samples by compressing the N4 predicted CSI instances using the determined N4 compression ratios. For example, the WTRU may determine a first compressed sample based on a first predicted CSI instance (e.g., of the N4 predicted CSI instances) and a first compression ratio (e.g., of the N4 compression ratios). Additionally or alternatively, the WTRU may determine a first compressed sample based on one or more predicted CSI instance(s), a first compression ratio, and/or one or more measured samples of the K channel samples.

The WTRU may determine a reporting mode as a function of the N4 determined compression ratios, and the available UL resources (e.g., Mode 1: Joint transmission of the N4 compressed samples, Mode 2: Separate transmission of the N4 compressed samples, Mode 3: Mode 1+measured prediction performance, or Mode 4: Mode 2 +measured prediction performance).

The WTRU may report the N4 compressed samples (e.g., possibly as a function the determined reporting mode). The report may include one or more of the determined N4 compression ratios, the determined reporting mode (e.g., a 2-bits flag), the determined estimate of the prediction accuracy, and/or an updated mapping table.

1. A wireless transmit/receive unit (WTRU) comprising:
a memory and a processor, wherein the processor is configured to:
receive configuration information associated with temporal-domain channel state information (CSI) prediction and compression, wherein the configuration information indicates a set of compression ratios associated with compression of predicted CSI instances;
receive CSI reference signals (CSI-RSs) in an observation window;
perform one or more first measurements on first channel samples in the observation window;
perform artificial intelligence machine learning (AIML) based prediction of one or more channel instances to determine one or more predicted channel instances;
perform one or more second measurements on the one or more predicted channel instances;
determine an estimated prediction accuracy for each of the one or more predicted channel instances based on the one or more first measurements and the one or more second measurements;
determine a compression ratio from the set of compression ratios for each of the one or more predicted channel instances based on the one or more first measurements and the determined estimated prediction accuracy; and
send compressed samples to the network in a report, wherein the report indicates the determined compression ratio for each of the one or more predicted channel instances.

2. The WTRU of claim 1, wherein the processor is further configured to determine the compressed samples by compressing the one or more predicted channel instances using the determined compression ratio associated with the respective predicted channel instance.

3. The WTRU of claim 2, wherein a first compressed sample is determined based on a first predicted channel instance of the one or more predicted channel instances and a first compression ratio.

4. The WTRU of claim 3, wherein the first compressed sample is determined based on the one or more first measurements.

5. The WTRU of claim 1, wherein the configuration information indicates one or more of a CSI-RS and CSI report configuration, a configuration of measurements for prediction accuracy estimation, a method and parameters for prediction accuracy estimation, an indicator to drop reporting of one or more CSI instances, or a reporting configuration.

6. The WTRU of claim 1, wherein the one or more first measurements comprise one or more of a coherence time, a doppler measurement, a time domain channel property (TDCP) with one or more configured delays, a WTRU speed, a received signal received power (RSRP), or a signal to interference noise ratio (SINR).

7. The WTRU of claim 1, wherein the one or more second measurements comprise one or more of out of distribution (OOD) detection, an anomalies rate, a distribution drift, a deviation between samples, a cross-correlation between the one or more predicted channel instances.

8. The WTRU of claim 1, wherein the estimated prediction accuracy for each of the one or more predicted channel instances is determined by comparing differences between the one or more first measurements and the one or more second measurements with configured thresholds.

9. The WTRU of claim 1, wherein the processor is further configured to:
calculate one or more key performance indicators; and
update a prediction accuracy mapping table based on the one or more second measurements.

10. The WTRU of claim 9, wherein the estimated predication accuracy for each of the one or more predicted channel instances is determined based on the updated prediction accuracy mapping table.

11. A method performed by a wireless transmit/receive unit (WTRU), the method comprising:
receiving configuration information associated with temporal-domain channel state information (CSI) prediction and compression, wherein the configuration information indicates a set of compression ratios associated with compression of predicted CSI instances;
receiving CSI reference signals (CSI-RSs) in an observation window;
performing one or more first measurements on first channel samples in the observation window;
performing artificial intelligence machine learning (AIML) based prediction of one or more channel instances to determine one or more predicted channel instances;
performing one or more second measurements on the one or more predicted channel instances;
determining an estimated prediction accuracy for each of the one or more predicted channel instances based on the one or more first measurements and the one or more second measurements;
determining a compression ratio from the set of compression ratios for each of the one or more predicted channel instances based on the one or more first measurements and the determined estimated prediction accuracy; and
sending compressed samples to the network in a report, wherein the report indicates the determined compression ratio for each of the one or more predicted channel instances.

12. The method of claim 11, wherein the processor is further configured to determine the compressed samples by compressing the one or more predicted channel instances using the determined compression ratio associated with the respective predicted channel instance.

13. The method of claim 12, wherein a first compressed sample is determined based on a first predicted channel instance of the one or more predicted channel instances and a first compression ratio.

14. The method of claim 13, wherein the first compressed sample is determined based on the one or more first measurements.

15. The method of claim 11, wherein the configuration information indicates one or more of a CSI-RS and CSI report configuration, a configuration of measurements for prediction accuracy estimation, a method and parameters for prediction accuracy estimation, an indicator to drop reporting of one or more CSI instances, or a reporting configuration.

16. The method of claim 11, wherein the one or more first measurements comprise one or more of a coherence time, a doppler measurement, a time domain channel property (TDCP) with one or more configured delays, a WTRU speed, a received signal received power (RSRP), or a signal to interference noise ratio (SINR).

17. The method of claim 11, wherein the one or more second measurements comprise one or more of out of distribution (OOD) detection, an anomalies rate, a distribution drift, a deviation between samples, a cross-correlation between the one or more predicted channel instances.

18. The method of claim 11, wherein the estimated prediction accuracy for each of the one or more predicted channel instances is determined by comparing differences between the one or more first measurements and the one or more second measurements with configured thresholds.

19. The method of claim 11, further comprising:
calculating one or more key performance indicators; and
updating a prediction accuracy mapping table based on the one or more second measurements.

20. The WTRU of claim 19, wherein the estimated predication accuracy for each of the one or more predicted channel instances is determined based on the updated prediction accuracy mapping table.
